(19) United States
(12) Patent Application Publication
(10) Pub. No.: US 2016/0062978 A1
(43) Pub. Date: Mar. 3, 2016

(54) METHOD AND SYSTEM FOR CUSTOMIZING THE PRESENTATION OF CONTENT TO SUBSCRIBERS

(71) Applicant: Steven Newman, Asheville, NC (US)

(72) Inventor: Steven Newman, Asheville, NC (US)

(21) Appl. No.: 14/471,054

(22) Filed: Aug. 28, 2014

(51) Int. Cl. G06F 17/24; G06F 17/30; G06F 17/21

(52) U.S. Cl. CPC G06F 17/248; G06F 17/212; G06F 17/30876; G06F 17/30896

(57) ABSTRACT

There is provided a method for designating a delivery batch of content to be delivered that includes the steps of: (1) performing a step of selecting a content silo and (2) performing a step of choosing a source type with respect to the selected content silo, The method can also include performing a step of indicating a respective tag that is associated with the respective source type that has been chosen with respect to the selected content silo.

### BACKGROUND OF THE INVENTION

Organizations have found that there are many benefits to provide content to the users of the Internet and mobile phone users. The content provided to such readers may take many forms, including, for example, articles, blurbs, and web logs (“blogs”), among others. In one approach, news content is published by inserting it into a web page, which can then be viewed using a web browser.

There are drawbacks, however, to this approach. Users who wish to see content from a variety of sources must typically visit many different web sites. In addition, if the user later wants to obtain the most current content from all the sources, they must visit all the different web sites again. This is very time consuming, especially if the user is interested in many different types of content and/or sources.

In the context of an organizational environment (e.g., a commercial, educational or governmental organization). It is desirable to provide the members of the organization with particular relevant content so that, for example, personnel are kept up to date on industry news, company news and/or current events generally. Some organizations allow members or employees to access feeds by allowing them to utilize web browsing resources (e.g., browser-enabled computers) owned by the organization, but problematically, the organizations are often unable to satisfactorily manage the particular feeds accessed by the members or employees. In other organization, members do not have access to the Internet, and as a consequence, they are unable to access any content feeds at all.

Additionally, organizations are very interested in providing relevant content to potential new members or customers. These potential new members or customers often have an initial contact with an organization as a subscriber to advertising, marketing information, or other content that is distributed by the organization.

The existing approaches for selecting content and delivering content to subscribers still leaves room for improvement. Also, it would be desirable if a subscriber could optimally customize the content delivery event itself, including customizing the relevancy of the content provided and the timing of the content delivery. Accordingly, a new method to provide relevant content would improve the landscape of content delivery and provide other new and innovative features.

### SUMMARY OF THE INVENTION

One object of the present invention is to provide a method for designating a delivery batch of content to be delivered that includes the steps of: (1) performing a step of selecting a content silo and (2) performing a step of choosing a source type with respect to the selected content silo, and (3) performing a step of indicating a respective tag that is associated with the respective source type that has been chosen with respect to the selected content silo. Performing the step of selecting a content silo includes (a) accessing an enumeration of content silos and (b) selecting one of the enumerated content silos. In connection with further details of the step of selecting a content silo, this step includes (a) accessing an enumeration of content silos and (b) selecting one of the enumerated content silos. The step of choosing a source type with respect to the selected content silo includes: (a) accessing an enumeration of source types, each enumerated source type being an eligible source type for the respective content silo that has been selected, and (b) choosing one of the enumerated source types. The method can optionally include performing a step of indicating a respective tag that is associated with the respective source type that has been chosen with respect to the selected content silo. The step of performing a step of indicating a respective tag that is associated with the respective source type that has been chosen with respect to the selected content silo includes: (a) accessing an enumeration of tags, each enumerated tag being an eligible tag in that the tag has been associated with the respective source type that has been chosen with respect to the selected content silo, and (b) indicating the respective tag.

According to optional features of the method of the present invention, the method may further include the step of creating a template for structuring the presentation of the content to be received by a user, the template including content that has been selected from among content that has been identified to the user and/or including content that remains after other content has been removed and the template specifying a time of delivery of content to the user.

Furthermore, the method may optionally include repeating the steps to form a plurality of indicated tags, retrieving the respective content associated with the indicated tags to form a delivery batch of content to be delivered, the delivery batch of content being in the form of tagged distributable content, and providing the retrieved content to a recipient. Also, the method may optionally include formatting the tagged distributable content in a human-legible format for presentation to a recipient.

A further object of the present invention is to provide a tangible computer-readable medium for storing instructions for controlling a computing device to generate an output, the instructions controlling the computing device to perform steps comprising: (a) from a collection of tagged distributable content, performing a step of forming a discrete batch of content from data relating to selected items of the tagged distributable content, the step being performed in response to input from a user who has selected a content silo, chosen a source type with respect to the selected content silo, and indicated a respective tag that is associated with the respective source type that has been chosen with respect to the selected content silo, and (b) formatting the discrete batch of content in a human-legible format for presentation to a recipient.

Other aspects, embodiments and advantages of the present invention will become apparent from the following detailed description which, taken in conjunction with the accompanying drawings, illustrate the principles of the invention by way of example.

### BRIEF DESCRIPTION OF THE DRAWINGS

The foregoing and other objects, features and advantages of the present invention, as well as the invention itself, will be more fully understood from the following description of various embodiments when read together with the accompanying drawings. In which:

FIG. 1A is a schematic illustration of one possible sequence of steps that may be performed to create the tagged distributable content in connection with the method of the present invention;

FIG. 1B is a schematic illustration of one possible sequence of steps that may be performed to customize a template in connection with the method of the present invention;

FIG. 2 is a schematic illustration of an exemplary implementation of the method of the present invention, wherein a content provider performs the method to provide content to a plurality of subscribers; and

FIG. 3 is a schematic illustration of core elements of the exemplary implementation of the method of the present invention shown in FIG. 2 and schematically showing the batch of content to be delivered as a group of tagged distributable content.

### DETAILED DESCRIPTION OF AN EMBODIMENT OF THE INVENTION

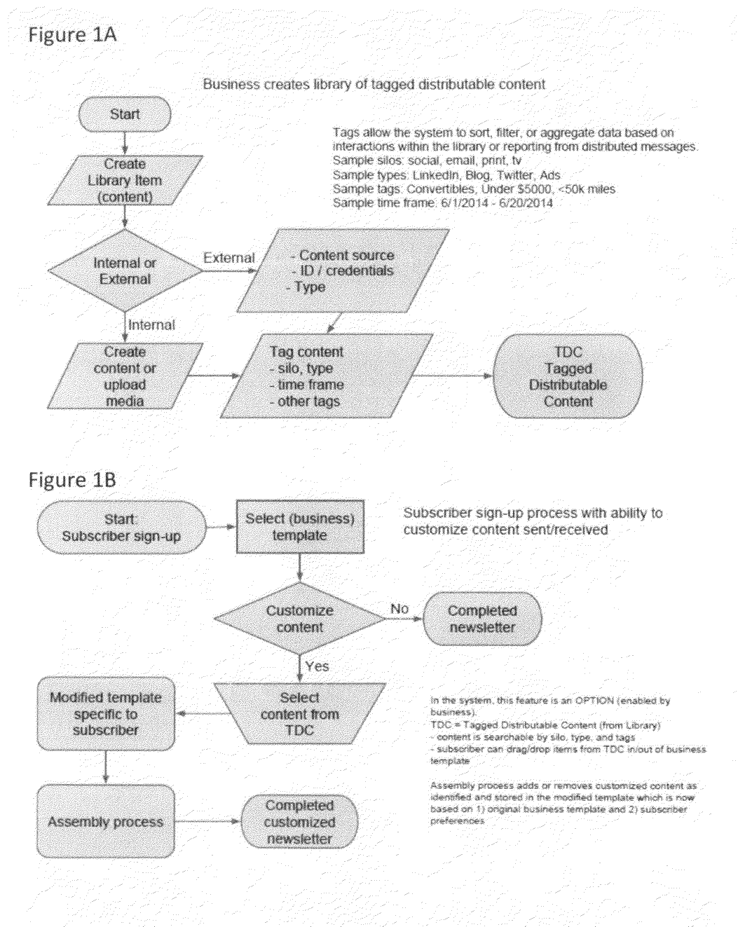

Reference is had to FIG. 1A, which is a schematic illustration of one possible sequence of steps that may be performed to create the tagged distributable content in connection with the method of the present invention and FIG. 1B, which is a schematic illustration of one possible sequence of steps that may be performed to customize a template in connection with the method of the present invention. The inventive method is a method for designating a delivery batch of content to be delivered that includes the steps of: (1) performing a step of selecting a content silo, (2) performing a step of choosing a source type with respect to the selected content silo, and (3) performing a step of indicating a respective tag that is associated with the respective source type that has been chosen with respect to the selected content silo.

The method of the present invention is suitable for execution by an organization for its own internal purposes including the purposes, for example, of providing customized delivery of content to members of the organization. Additionally or alternatively, the method of the present invention is suitable for execution by a group of subscribers, wherein the content is curated by a third party content provider. In this regard, an example of such a curated content provision system will now be described and this system, hereinafter denominated as the “Business and Customer Defined Content Distribution System”, allows a subscriber to select content from any and all business content verticals to be consolidated and distributed via a single digital message (email or SMS) within a customer-specified timeframe.

The exemplary Business and Customer Defined Content Distribution System can be structured and implemented as set forth in the following discussion.

Regarding the content silos that are referenced during the implementation of the method, the following are examples of Business Content Verticals (using Forrester RaDar model):

RaDaR (Reach and Depth and Relationship) Model Silos (not exclusionary):
Reach Silos: TV. Radio, Search (web), Mobile App, In-Store, Print, YouTube, Website, BLOG, Social (“Social”) Media Sites

### Depth Silos: Mobile (SMS), Social, Sales, Store, Loyalty Program(s), Postal Mail

Electronic Mall (email), Phone
Relationship Silos: Website (blogs, mobile), Store, Sales

### Example

Mr. John Smith selects to receive TV ads (video). In-Store announcements (at his local store), Email Newsletter Content (by vertical), CEO Twitter Posts, and Blog Posts in his weekly newsletter.

2. The exemplary Business and Customer Defined Content Distribution System allows a subscriber to select the layout, format, and branding for their received piece of electronic mail (and selected content).

3. The exemplary Business and Customer Defined Content Distribution System allows the company (implementing this system) to categorize and centralize all forms of business content via a centralized and distributed platform or service. Collecting metrics across interactions with their content gives the company a broad-scope view of their global data/content consumption (applied Business Intelligence and Analytics).

The provision of content via a system such as the exemplary Business and Customer Defined Content Distribution System described herein can provide a number of benefits including, among other benefits, the following benefits:
1. An overall reduction of email traffic to subscribers (who are inundated by excessive volume of email). This also saves the business money in message quota and earns better business reputation digitally by better controlling and managing the flow of emails through gateways and email service providers.
2. An email to the subscriber that the subscriber actually wants (and asked for).
3. Satisfying the actual needs and wants of the subscriber (customer focused marketing).
4. An identification to the company as to what pieces of content are desirable, actionable, useful, profiting, and efficient.
5. A system that can globally identify and compare corporate impacts of marketing strategies (email, advertising, sales, print, etc).

The exemplary Business and Customer Defined Content Distribution System can be comprised of any suitable configuration of sub-systems that cooperate to provide the advantages of a content provision system that accrues in accordance with the present invention. To this end, the exemplary Business and Customer Defined Content Distribution System can comprise the following sub-systems:

Email Distribution Sub-System
1. To also include SMS distribution
2. Applies subscriber profile rules to business' content management rules to ensure proper content is received within specified time-frame
3. Assembles and distributes bulk or individual digital messages to subscribers Content Library
1. Content generation sub-system
   i. Allows the business to create and store articles, ads, or any piece of content to be distributed digitally
   ii. Allows other members to also generate content that a business can purchase, lease, or share based on the original owner's consent
2. Content management sub-system
   i. Includes rules on when any piece of content can be distributed
   ii. Allows the business to add, edit, or remove any content from their library
   iii. Provides a means by which specific users with specific rights are permitted to create, modify, or destroy content
3. Content pointers (for sourcing and using external content)
   i. Examples of Social Media sites: LinkedIn, Twitter, YouTube
   ii. Examples of other external content: blogs, RSS
   iii. The content pointer sub-system will securely store the appropriate identities and privileges necessary to access the content
4. Content tag sub-system which allows the business to aggregate and report based on business identified tags

Newsletter template sub-system which allows the business/customer to construct text or HTML newsletters, themes, and templates as well as specify what types of content from their library can be included in each newsletter to be distributed.

Subscriber Profile Sub-System
1. Allows the subscriber to select which business template (from 3 above) they wish to receive
2. Allows the subscriber to select or remove any and all pieces of content identified from the business' content library
3. Allows the subscriber to specify when a business can distribute electronic messages to them (example, daily, weekly, etc)

Reporting sub-system that reflects all subscriber interactions with any form of distribution (email. SMS, web display, etc)
1. Gives the business the ability to view interactions based on emails, tags, campaigns, etc.
2. Often referred to as business intelligence or big data.

Basic Customer Relationship Management (CRM)
1. To allow reporting and viewing of individual subscriber interactions.

Enterprise security model (where individuals within a company can be assigned proper rights to create, edit, or destroy data within each sub-system.

Predictive Analytics
1. Allows the company to provide templates or models to best suit business goals and needs
2. Allows the licensee to also predict and present best use cases of content models

The exemplary Business and Customer Defined Content Distribution System provides advantages to the subscribers including advantages such as the following:
1. Used to consolidate email traffic for a subscriber/customer and give them everything they want or need within a single point of contact (customer focused marketing).
2. Used by a company to identify, execute, evaluate, and compare marketing and content strategies.
3. Used by a company to unify and improve the overall customer experience.
4. Used by a company to satisfy their customers' needs.

A curated content provision system, such as the Business and Customer Defined Content Distribution System described herein, can be comprised of any suitable sub-systems and components that configure the system to provide the advantages of the present invention. Such sub-systems or components could include a subscriber enrollment database that provides relevant information for controlling the subscriber enrollment process and controlling the subscriber access rights. A content aggregator can be provided to permit the third party content provider to define and supply the respective content feeds that can be accessed by, or customized for, the subscribers and to access the subscriber enrollment database to identify subscribers.

Some of the advantages and benefits accruing to both a third party content provider and an organization subscribing to a content provision system have been noted in connection with the exemplary Business and Customer Defined Content Distribution System described herein, a clearer understanding of the scope and parameters of the method of the present invention can be gained via another exemplary description of a hypothetical implementation of the method of the present invention. In the following scenario, an organization denominated as ACME Business (herein “ACME”) is an online retailer of home and automobile media equipment (audio-visual products/AV). The products they sell include car stereos, home stereos, car stereo accessories, home theatre equipment, TVs, and other miscellaneous products. These products range in price from entry-level price points (in connection with equipment items typically less than $100) to high-end price points (in connection with systems where each piece of equipment is over $1,000). Every week, ACME gives a special discount to specific product categories, denominated as “verticals” (car stereos, TVs, etc).

ACME, as part of their content distribution on the internet, has an assortment of experts that communicate socially with their audience talking about the products they offer and giving guidance. Such activities are focused on communications via Web-based social media channels such, as for example, Facebook and Twitter. ACME's CEO also posts a weekly message (via the social media channel Twitter) with a link to the hot product of the week where followers can get the deepest discount ACME offers.

As part of ACME's product line involves business-related audio-visual products, ACME's business-to-business (“B2B”) sales department focuses most of their attention on communications via appropriate Web-based media channels such as, for example, LinkedIn.

ACME participates in pay-per-click advertising for its top-selling product lines: car stereo units and B2B-focused projectors. These ads are simple graphics with a link to a landing page on their website.

Finally, ACME produces a quarterly magazine they distribute via ground mail. In this scenario. ACME plans to digitize that magazine and have it available to their email newsletter subscribers.

ACME's employee's contributing to these efforts are:

Joe Davis—CEO, writing on Twitter
John Doe—writing for Facebook
Jane Smith—writing for Twitter
Alex Johnson—writing for LinkedIn

One possible implementation of the content provision system of the present invention and the method of the present invention for accessing such a content provision system could involve any of the following scenarios:

In their setup process, ACME would identify they are using or creating content for the following silos: social, website, print.

All content within the system can be sorted, filtered, or reported by their silo; the silo is considered the top-level organizational structure for content within a given businesses account.

In the system, ACME could then create the following tags which can be applied to any piece of content:
1. car head-unit
2. car speaker
3. car stereo
4. home stereo
5. home amplifier
6. home stereo speaker
7. home theatre projector
8. TVs
9. B2B A/V equipment
10. entry-level equipment
11. high-end equipment
12. Joe Davis (Twitter)
13. John Doe Facebook
14. Jane Smith (Twitter)
15. Alex Johnson (LinkedIn)
16. Quarterly magazine
17. Weekly special

Based on this example, ACME could create library items that attach to or point to content created or stored outside the system; when these items are identified, the system will store the appropriate information in order to access and then display them via digital messaging:
1. Silo: Social
   i. Type: Twitter
      1. Tag: Joe Davis
      2. Tag: Jane Smith
   ii. Type: Facebook
      1. Tag: John Doe
   iii. Type: LinkedIn
      1. Tag: Alex Johnson
      2. Tag: B2B

Based on this example, ACME could then create additional library content items as follows:
1. Silo: Print
   i. Type: Quarterly magazine
2. Silo: Advertising
   i. Type: PPC
      1. Content 1: car stereo head-unit offer
      2. Graphic of advertising with link to landing page
      3. Tags: car head-unit
   ii. Type: PPC
      1. Content 2: B2B projector
      2. Graphic of advertising with link to landing page
      3. Tags: B2B A/V equipment, high-end equipment
3. Silo: Website
   i. Type: Weekly Special
      1. Content 1: First week of the month special
      2. Tags: home stereo, weekly special
      3. Time frame: start of week, end of week
   ii. Type: Monthly Special
      1. Content 2: Second week of the month special
      2. Tags: car stereo, weekly special
      3. Time frame: start of week, end of week
   iii. Type: Product Review
      1. Content 3: Product review of three entry-level car stereo head-units
      2. Tags: entry level, car stereo, car head-unit
      3. Time frame: start of month, end of month

ACME has (at this point) created its library of content and will continue to develop and store other pieces of content it wishes to distribute.

ACME uses the system to build an HTML template (or many templates) to use as a model for email newsletters to distribute to their subscribers.

When ACME is ready to distribute or set-up the distribution of a newsletter.

ACME uses the template as its model:
1. Within that newsletter, ACME can create a section or block of content inside the newsletter that is not stored within the library, but only used for that specific newsletter or template distribution.
2. Within that newsletter, ACME can drag-and-drop any piece of content from their library INTO the template or newsletter.
3. Within that newsletter, ACME can drag-and-drop variable pieces of content based on silos and tags.

For the purpose of this example, ACME creates a template newsletter that has 1 fixed block and four variable blocks in it and has this basic structure:
1. Fixed Masthead (at the top): logo, business name, contact information
2. Variable Block 1: Silo: Social
3. Variable Block 2: Silo: Social, Tags: B2B
4. Variable Block 3: Silo: Print
5. Variable Block 4: Silo: Website
6. It should be noted that a business can deploy standard email marketing content without giving the subscriber any control by not including any variable blocks
7. It should also be noted that ACME could create various templates with specific types or tags already associated to variable blocks so that when a subscriber wishes only to subscriber to their B2B product verticals, they can do so quickly and easily.

ACME schedules this newsletter to send to all their subscribers every Monday at 6 AM EST.

When an individual comes to ACME's website and subscribes to ACME's newsletter, and that newsletter/template has variable content blocks specified, this is the process that can be followed:
1. Subscriber enters their email address for distribution
2. Other demographics and information can be collected at this time as well
3. Upon submitting the subscriber's information, a confirmation screen is displayed with the following (as related to this system only):
   i. A version of the template showing the type of content the subscriber can expect, specifically, each of the blocks as identified in number 9 above
   ii. A statement indicating that this content is distributed weekly on Mondays at 6 am EST.
   iii. A link indicating that the subscriber has the ability to customize this template with their own preferences, via an advanced customization process or procedure.
   iv. If that link is clicked, the new page displayed could look like this:
      1. A graphic display of the content silos ACME has deployed within its content library
         a. This content is dick-able such that if the subscriber clicks on a specific silo, the next level of categorization or tagging is displayed.
         i. Example, click on the Social silo and the next level of display is Type: Facebook, Twitter, LinkedIn
         ii. Example, click on Twitter and the next level of Tag is displayed: Joe Davis and Jane Smith
         b. In this manner, the subscriber has the ability to drill-down each silo to identify specific content they wish to receive in their newsletter.
         c. The system only lists or shows the actual structure or architecture that is established by the company when the company builds their library.
         d. In this manner, only the relevant silos, types, and tags are displayed (in that order of structure).
4. In this example, the template that is displayed has the ability for subscriber interaction, dragging and dropping content library items to and from the template as well as adding specific tags to the items within the template.
5. For this example, the particular subscriber is a direct consumer only interested in entry-level car stereo equipment and takes the following actions:
   i. Removes variable block 2 as they are not interested or involved in any B2B activities.
   ii. Customizes variable block 4 by adding the following tags (via drop-down box or drag-and-drop):
      1. entry-level equipment
      2. car stereo
6. The subscriber has the ability to change the distribution time to any time or frequency greater than that identified by the template
   i. Example: if the newsletter is scheduled daily, the subscriber can select weekly on any specific day of the week
   ii. Example: if the newsletter is scheduled weekly, the subscriber can select to receive the newsletter every other week or monthly, on any specific day they wish

Once the template is submitted by the subscriber, it is stored as a custom template in that subscriber's profile

When the date of the distribution of the newsletter is reached, the newsletter is assembled with the specified content and distributed, with specific reference to this example, the subscriber receives this in their first newsletter:
1. Fixed masthead.
2. Variable block 1 with latest posts (and links) from Joe Davis. Jane Smith, and John Doe.
3. Variable block 3 with an image of the magazine and link to its digital source on the ACME website.
4. Variable block 4 with “Content 2” and “Content 3”, as identified in 5c above, that match the tags specified by the subscriber in 11.e.ii.

Within each newsletter, at the bottom, is a link to the subscriber's preferences so they can adjust their custom template at any time; similarly, via the ACME website, a link to the customer's preferences can be accessed if provided.

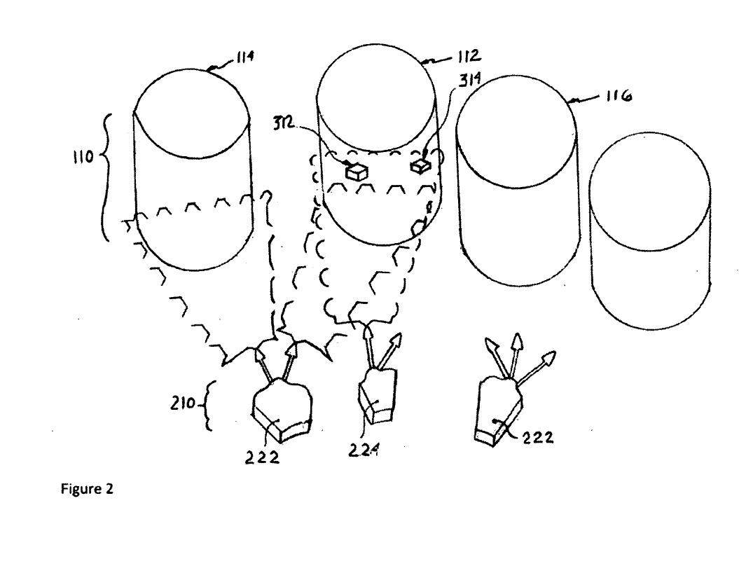

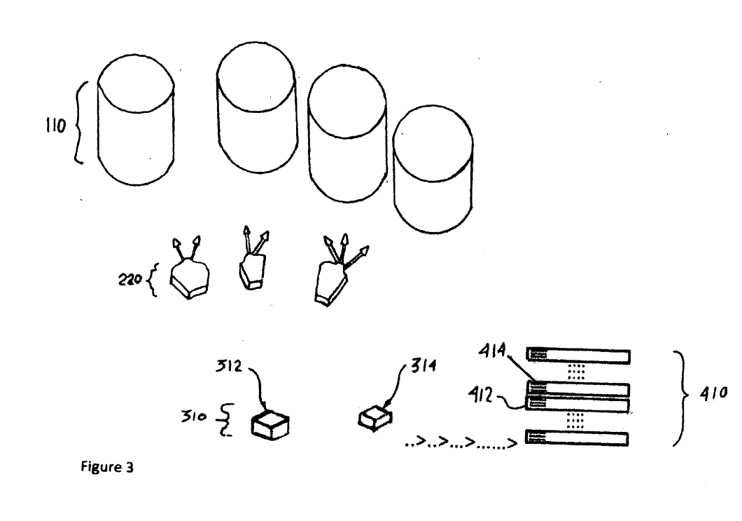

With reference to FIG. 2 and to FIG. 3, an exemplary execution of the method for designating a delivery batch of content to be delivered is illustrated. FIG. 2 is a schematic illustration of an exemplary implementation of the method of the present invention, wherein a content provider performs the method to provide content to a plurality of subscribers, and FIG. 3 is a schematic illustration of core elements of the exemplary implementation of the method of the present invention shown in FIG. 2 and schematically showing the batch of content to be delivered as a group of tagged distributable content. A plurality of content silos 110 have been configured by a content provider and each content silo comprises content that the content provider accesses to provide to subscribers. Solely for the sake of illustration, these content silos include a “Social” silo 112, a “Web” silo 114, and a “Print” silo 116. The term “silo” is used herein to refer to a repository of content that has been aggregated with respect to a common theme and the term “repository” as used herein encompasses a single physical location at which all of the thus-aggregated content is stored (i.e., residing on a single server) as well as a storage arrangement in which portions of the aggregated content are stored (i.e., multiple storage sites including cloud-based and non cloud-based storage). The “Social” silo 112 may comprise content having the common theme of being sourced or harvested from an Internet social interaction sources, the “Web” silo 114 may comprise content having the common theme of being sourced or harvested from an Internet information source and the “Print” silo 116 may comprise content having the common theme of being sourced or harvested from a printed source such as a magazine or a newspaper.

The content that is comprised in the content silos 110 can be sourced from a variety of sources and these sources are denominated as source types 220. FIG. 2 exemplarily illustrates a few representative source types 220 that form an enumerated list of source types from which content for the content silos 110 can be drawn including a source type 222 representative of a full media social distribution source type such as, for example, the social connection service Facebook, a source type 224 representative of a short message social distribution source type such as, for example, the connection service Twitter, and a source type 226 representative of a business or organization network service such as, for example, the network service LinkedIn.

The content that is comprised in the content silos 110 can thus be characterized via reference to the respective source type 220 from which the content is drawn. For example, one category of content that is comprised in the content silos 110 can be characterized as content drawn from the source type 222—i.e., drawn from a full media social distribution source type such as, for example, the social connection service Facebook. Additionally, the content that is comprised in the content silos 110 can be characterized via reference to one or more tags in an enumerated list of tags 310. A tag 312, as an example, can indicate content that has been contributed by a particular content contributor such as Joe Davis noted in the given example and another tag 314 can indicate content that has been contributed by a particular content contributor such as Jane Smith noted in the given example. The content with which the tag 312 is associated is denominated as “tagged distributable content” and, as seen in FIG. 3, the particular content with which the tag 312 is associated is one element of a collection of tagged distributable content 410—namely, the content with which the tag 312 is associated is accessible as a tagged distributable content element 412. The content with which the tag 314 is associated is also denominated as “tagged distributable content” and, as seen in FIG. 3, the particular content with which the tag 314 is associated is one element of the collection of tagged distributable content 410—namely, the content with which the tag 314 is associated is accessible as a tagged distributable content element 414.

With continuing reference to FIG. 2 and FIG. 3, the method for designating a delivery batch of content to be delivered includes: (1) performing a step of selecting a content silo, (2) performing a step of choosing a source type with respect to the selected content silo, and (3) performing a step of indicating a respective tag that is associated with the respective source type that has been chosen with respect to the selected content silo. Performing the step of selecting a content silo includes (a) accessing an enumeration of content silos and (b) selecting one of the enumerated content silos. In the example illustrated in FIG. 2 and FIG. 3, the enumeration of content silos includes the content silos 110—namely, the “Social” silo 112, the “Web” silo 114, and the “Print” silo 116—and the selected one of the enumerated content silos 110 is the “Social” silo 112. Performing the step of choosing a source type with respect to the selected content silo includes: (a) accessing an enumeration of source types, each enumerated source type being an eligible source type for the respective content silo that has been selected, and (b) choosing one of the enumerated source types. Continuing further with the example illustrated in FIG. 2 and FIG. 3, accessing an enumeration of source types includes accessing the source types 220 and it can be seen that the enumerated source types that are eligible source types in connection with the respective content silo (the “Social” silo 112) that has been selected are the source type 224 representative of a short message social distribution source type such as, for example, the connection service Twitter, and the source type 226 representative of a business or organization network service such as, for example, the network service LinkedIn. In the example illustrated, the source type 222 representative of a full media social distribution source type such as, for example, the social connection service Facebook, is not an eligible source types in connection with the respective content silo under consideration (the “Social” silo 112). Continuing further with the example illustrated in FIG. 2 and FIG. 3, performing the step of choosing a source type with respect to the selected content silo also includes choosing one of the enumerated source types—in this case, the chosen source type is the source type 224 representative of a short message social distribution source type such as, for example, the connection service Twitter.

Performing the step of indicating a respective tag that is associated with the respective source type that has been chosen with respect to the selected content silo includes: (a) accessing an enumeration of tags, each enumerated tag being an eligible tag in that the tag has been associated with the respective source type that has been chosen with respect to the selected content silo, and (b) indicating the respective tag. Continuing further with the example illustrated in FIG. 2 and FIG. 3, accessing an enumeration of tags includes accessing the tags 310 and indicating the respective tag includes indicating the tag 312 (which is accessible as the tagged distributable content element 412) and indicating the tag 314 (which is accessible as the tagged distributable content element 414). By performing a cycle of the method for designating a delivery batch of content to be delivered, the subscriber is able to receive content contributed by Joe Davis (the tagged distributable content element 412) and Jane Smith (the tagged distributable content element 414).

The present invention also contemplates that content can be provided to a subscriber, wherein the provided content has been drawn together via a selection process in which a respective content silo has been selected and a source type with respect to the selected content silo has been chosen but no respective tags have yet been indicated to further cull the content. In this scenario, it is contemplated that it is left to the discretion of the subscriber to indicate (i.e., apply) selected tags to the provided content and this approach thus presents further opportunities for a subscriber to customize the content. Any suitable approach can be taken by a subscriber for applying a tag or tags to the provided content including, for example, the approach that a subscriber calls up a tag template comprising a listing of desired or frequently viewed tags and applies the tag template to the provided content. Another suitable approach could include using no tags at all for the selected type of content whereby all distributed content within that type is then available for the subscriber to view. A further suitable approach could include a subscriber interacting with the content provider and requesting the content provider to select and apply relevant tags in subject areas indicated by the subscriber, or to apply tags indicated by the subscriber with the content provider then returning to the subscriber a refined batch of content ready for consumption by the subscriber without further processing.

The method of the present invention can be executed manually but is preferably executed via a tangible computer-readable medium for controlling a computing device to generate an output. This tangible computer-readable medium may be connected (e.g., networked) to other machines in a Local Area Network (LAN), an intranet, an extranet, or the Internet. The tangible computer-readable medium may operate in the capacity of a server or a client machine in a client-server network environment, or as a peer machine in a peer-to-peer (or distributed) network environment. The tangible computer-readable medium may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to execute the steps of the method of the present invention.

Unless specifically stated otherwise, it will be appreciated that throughout the description of the present invention, use of terms such as “processing”, “computing”, “calculating”. “determining”. “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. Further, various embodiments of the present invention may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML. SGML, XML, VoXML), and the like, as well as object-oriented environments such as the Java object-oriented environment and the like. In general, however, all of the aforementioned terms as used herein are meant to encompass any series of logical steps performed in a sequence to accomplish a given purpose.

The present invention can be implemented with an apparatus to perform the operations described herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks. CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and processes presented herein are not inherently related to any particular computer or other apparatus. Various general-purpose systems may be used with programs in accordance with the teachings herein, or it may prove convenient to construct more specialized apparatus to perform the required method. For example, the method according to the present invention can be implemented in hard-wired circuitry, by programming a general-purpose processor or by any combination of hardware and software.

One of ordinary skill in the art will immediately appreciate that the invention can be practiced with computer system configurations of any type, including hand-held devices, multiprocessor systems, microprocessor-based or programmable consumer electronics, DSP devices, network PCs, minicomputers, mainframe computers, personal computers, and the like. The invention can also be practiced in distributed computing environments where tasks are performed by remote processing devices that are linked through a communications network.

What is claimed is:

1. A method for designating a delivery batch of content to be delivered, the method comprising:
i. performing a step of selecting a content silo, the step including:
(a) accessing an enumeration of content silos, and
(b) selecting one of the enumerated content silos;
ii. performing a step of choosing a source type with respect to the selected content silo, the step including:
(a) accessing an enumeration of source types, each enumerated source type being an eligible source type for the respective content silo that has been selected, and
(b) choosing one of the enumerated source types; and
iii. performing a step of indicating a respective tag that is associated with the respective source type that has been chosen with respect to the selected content silo, the step including:
(a) accessing an enumeration of tags, each enumerated tag being an eligible tag in that the tag has been associated with the respective source type that has been chosen with respect to the selected content silo, and
(b) indicating the respective tag.

2. The method according to claim 1 and further comprising the step of creating a template for structuring the presentation of the content to be received by a user, the template including content that has been selected from among content that has been identified to the user and/or including content that remains after other content has been removed and the template specifying a time of delivery of content to the user.

3. The method according to claim 1, wherein the source types include a full media social distribution source type, a short message social distribution source type, a business or organization network service source type.

4. The method according to claim 1 and further comprising repeating the steps i though iii to form a plurality of indicated tags, retrieving the respective content associated with the indicated tags to form a delivery batch of content to be delivered, the delivery batch of content being in the form of tagged distributable content, and providing the retrieved content to a recipient.

5. The method according to claim 1 and further comprising formatting the tagged distributable content in a human-legible format for presentation to a recipient.

6. A tangible computer-readable medium for storing instructions for controlling a computing device to generate an output, the instructions controlling the computing device to perform steps comprising:
(a) from a collection of tagged distributable content, performing a step of forming a discrete batch of content from data relating to selected items of the tagged distributable content, the step being performed in response to input from a user who has selected a content silo, chosen a source type with respect to the selected content silo, and indicated a respective tag that is associated with the respective source type that has been chosen with respect to the selected content silo,
(b) formatting the discrete batch of content in a human-legible format for presentation to a recipient.

7. The tangible computer-readable medium for storing instructions for controlling a computing device to generate an output according to claim 6 and further providing a template for structuring the presentation of the content to be received by a user, the template including content that has been selected from among content that has been identified to the user and/or including content that remains after other content has been removed and the template specifying a time of delivery of content to the user.

8. The tangible computer-readable medium for storing instructions for controlling a computing device to generate an output according to claim 7, wherein the source types include a full media social distribution source type, a short message social distribution source type, a business or organization network service source type.

9. A method for designating a delivery batch of content to be delivered, the method comprising:
i. performing a step of selecting a content silo, the step including:
(a) accessing an enumeration of content silos, and
(b) selecting one of the enumerated content silos; and
ii. performing a step of choosing a source type with respect to the selected content silo, the step including:
(a) accessing an enumeration of source types, each enumerated source type being an eligible source type for the respective content silo that has been selected, and
(b) choosing one of the enumerated source types.

10. The method according to claim 9 and further comprising the step of performing a step of indicating a respective tag that is associated with the respective source type that has been chosen with respect to the selected content silo, the step including accessing an enumeration of tags, each enumerated tag being an eligible tag in that the tag has been associated with the respective source type that has been chosen with respect to the selected content silo and indicating the respective tag.

11. The method according to claim 10 and further comprising the step of creating a template for structuring the presentation of the content to be received by a user, the template including content that has been selected from among content that has been identified to the user and/or including content that remains after other content has been removed and the template specifying a time of delivery of content to the user.
